(19) United States
(12) Patent Application Publication
(10) Pub. No.: US 2007/0039200 A1
(43) Pub. Date: Feb. 22, 2007

(54) Drying apparatus

(76) Inventor: Sung Gi Hwang, Changwon-si (KR)

Correspondence Address: FLESHNER & KIM, LLP, P.O. BOX 221200, CHANTILLY, VA, 20153, US

(21) Appl. No.: 11/437,879

(22) Filed: May 22, 2006

(30) Foreign Application Priority Data
May 23, 2005 (KR) 10-2005-0043011

(51) Int. Cl. F26B 3/00; F26B 21/08

(52) U.S. Cl. 34/474; 34/557

(57) ABSTRACT

Disclosed herein is a drying apparatus which is capable of measuring the accurate dryness of an object being dried, regardless of the amount and position of the object received in a drying drum, thereby achieving an improvement in drying efficiency. The drying apparatus comprises a drum receiving an object to be dried, an air passage communicating with the interior of the drum, a blowing unit mounted in the air passage for forcibly blowing the inside air of the drum, and a humidity sensor mounted in the blowing unit for measuring the humidity of the air blown from the drum.

This application claims the benefit of the Korean Patent Application No. 10-2005-0043011 filed on May 23, 2005, which is hereby incorporated by reference as if fully set forth herein.

### BACKGROUND OF THE INVENTION

1. Field of the Invention

The present invention relates to a drying apparatus capable of accurately detecting the dryness of an object being dried, such as clothes, regardless of the amount and position of the clothes put in a drying drum.

2. Discussion of the Related Art

Generally, a drying apparatus is an appliance for automatically drying a completely washed wet object (for example, clothes). The drying apparatus may be classified into an exhaust-type drying apparatus for drying clothes using outside air, and a condensing-type drying apparatus for removing moisture from wet clothes via the circulation of inside air and discharging the removed moisture in the form of condensed water droplets so as to complete the drying of the clothes.

Of the above mentioned two types of drying apparatuses, now, a conventional exhaust-type drying apparatus will be explained schematically with reference to the accompanying drawing.

As shown in FIG. 1, the conventional drying apparatus comprises a body 10, a drying drum 20 rotatably disposed in the body 10 and adapted to dry a wet object put in the drying drum 20, a drum supporter 60 mounted at a front end of the drying drum 20 and adapted to rotatably support the drying drum 20, and a drive motor 50 connected to the drying drum 20 by use of a power transmission belt 55 and adapted to provide the drying drum 20 with rotating power.

A suction duct 30 is provided behind the drying drum 20 to suction outside air into the drying drum 20, and a heater 35 is mounted in an entrance of the suction duct 30 to heat the suctioned air.

A lint duct 40 is mounted in a front lower region of the drying drum 20. The lint duct 40 contains a filter 43 for filtering impurities such as lint contained in the inside air of the drying drum 20, so as to discharge the filtered air from the drying drum 20.

A blowing fan 45 is mounted at an end of the lint duct 40 and adapted to forcibly blow the air, having been suctioned through the lint duct 40, into an exhaust duct 15.

Here, the blowing fan 45 is mounted in a fan housing 44, and in turn, the fan housing 44 is mounted to communicate with the lint duct 40.

The blowing fan 45 is coupled to a drive shaft (not shown) extending in a direction opposite to a pulley 53 of the drive motor 50. Thereby, the blowing fan 45 is operated simultaneously with the operation of the drive motor 50.

Meanwhile, a dryness sensor 70 is mounted at the drum supporter 60 in the front lower region of the drying drum 20 and adapted to detect the dryness of an object being dried.

The dryness sensor 70 includes two metal plates arranged parallel to each other, and two electrical rod sensors (known as “rod humidity sensor”) mounted, respectively, on the metal plates while being connected to an electric wire.

If the object being dried is placed between the two metal plates, and thus, electrical connection is created therebetween, a controller (not shown) is able to read a resistance value of the drying object using the variation of a voltage. Thereby, the dryness sensor 70 can detect the dryness of the object being dried.

Specifically, if the wet object being dried comes into contact with both the metal plates simultaneously, a circuit of the dryness sensor 70 is electrically connected.

In such an electrically connected state, the object being dried acts as a resistor in the circuit. Thus, a microcomputer is able to read a resistance value of the object being dried by measuring a voltage value corresponding to the object being dried.

As the moisture content of the object being dried is reduced via a drying cycle, the resistance value of the object gradually increases in inverse proportion to the reduction of the moisture content.

In this case, the voltage value increases in proportion to the resistance value.

On the basis of the above described principle, if the measured voltage value reaches a predetermined value, the microcomputer determines the completion time point of the drying cycle, and commands to stop the operation of the drying apparatus.

However, the conventional drying apparatus having the above described configuration has the following problems.

Where an insufficient amount of object being dried is put in the drying drum 20, the dryness sensor 70 has a difficulty to accurately measure a resistance value that is generated from the object being dried.

That is, since the dryness sensor 70 is mounted in a limited region of the drying drum, more particularly, in the front lower region of the drum 20, the object being dried may often fail to come into contact with at least one of the two metal plates of the dryness sensor 70 during the drying cycle. Furthermore, even if the object being dried comes into contact with all the metal plates, an excessively low amount of object is insufficient to ensure continuous contact between the metal plates and the object being dried.

In this case, the metal plates of the dryness sensor 70 may incorrectly measure a higher resistance value than the actual resistance value of the object being dried. Accordingly, when the higher resistance value is input from the dryness sensor 70 to the microcomputer, the microcomputer inevitably misjudges the completion of the drying cycle in spite of the incomplete dryness of the object being dried, and commands to finish the operation of the drying apparatus prematurely.

As a result, there is an inconvenience in that the drying apparatus must be again operated after ending the drying cycle because of the incompletely dried laundry.

### SUMMARY OF THE INVENTION

Accordingly, the present invention is directed to a drying apparatus that substantially obviates one or more problems due to limitations and disadvantages of the related art.

An object of the present invention is to provide a drying apparatus which is capable of measuring the accurate dryness of an object being dried, regardless of the amount and position of the object received in a drying drum, thereby achieving an improvement in drying efficiency.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a drying apparatus comprises: a drum receiving an object to be dried; an air passage communicating with the interior of the drum; a blowing unit mounted in the air passage for forcibly blowing the inside air of the drum; and a humidity sensor mounted in the blowing unit for measuring the humidity of the air blown from the drum.

The blowing unit may include: a fan housing communicating with both the drum and air passage; and a blowing fan mounted in the fan housing, and the humidity sensor may be mounted to the fan housing.

The fan housing may have a through-hole, and the humidity sensor may be mounted on the fan housing around the through-hole.

The humidity sensor may be mounted to cover the through-hole at the outside of the fan housing.

The humidity sensor may include: a case having a vent hole perforated through a side thereof facing the interior of the fan housing; and a humidity sensing unit mounted in the case for measuring a humidity value of air introduced through the vent hole.

At least one vent hole may be provided.

The humidity sensing unit may include: a humidity sensing element having a variable resistance value depending on the humidity of air introduced through the vent hole; and a compensation element for compensating for a resistance value depending on the temperature of surrounding air.

The humidity sensing unit may further include a temperature compensation plate connected to both the humidity sensing element and compensation element for compensating for a temperature difference between the humidity sensing element and compensation element.

The fan housing may have a sensor seating rib formed at an outer surface thereof for allowing the humidity sensor to be seated thereon, and a fixture may be provided for fixedly coupling the humidity sensor to the sensor seating rib.

The sensor seating rib may take the form of a ring protruding from the outer surface of the fan housing along an outer periphery of the through-hole.

The fixture may include: a plurality of fastening portions extending radially from an outer periphery of the sensor seating rib; a plurality of fastening pieces formed at the humidity sensor to correspond to the fastening portions, respectively; and a plurality of screws penetrating through the fastening portions and fastening pieces, to fixedly couple the humidity sensor to the sensor seating rib.

At least one of the fastening portions of the sensor seating rib may be formed with an upwardly-extending guide protrusion, and at least one of the fastening pieces of the humidity sensor may be formed with a guide hole for the insertion of the guide protrusion.

At least one guide protrusion and at least one guide hole may be provided.

A shrinkage proof groove may be formed at an upper surface of the sensor seating rib in a circumferential direction.

The drying apparatus may further comprise a sealing member interposed between the sensor seating rib and the humidity sensor for achieving air tightness therebetween.

The above described exhaust-type drying apparatus according to the present invention can achieve the following effect.

The drying apparatus of the present invention can measure the dryness of the interior of a drying drum by detecting the humidity of air discharged from the drying drum without coming into direct contact with an object being dried. This has the effect of accurately measuring the dryness of the object being dried regardless of load.

With this accurate measurement of the dryness of the object being dried, the drying performance of the drying apparatus can be improved while achieving an increase in the user's satisfaction.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a longitudinal sectional view illustrating a conventional exhaust-type drying apparatus;

FIG. 2 is a longitudinal sectional view illustrating an exhaust-type drying apparatus according to a preferred embodiment of the present invention;

FIG. 3 is a plan sectional view illustrating the exhaust drying apparatus of FIG. 2 having no drying drum;

FIG. 4 is a perspective view illustrating a humidity sensor prior to being mounted in the exhaust-type drying apparatus of FIG. 2;

FIG. 5 is a perspective view illustrating the humidity sensor after being mounted in the exhaust-type drying apparatus of FIG. 2; and

FIG. 6 is a sectional view taken along the line I-I of FIG. 5.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

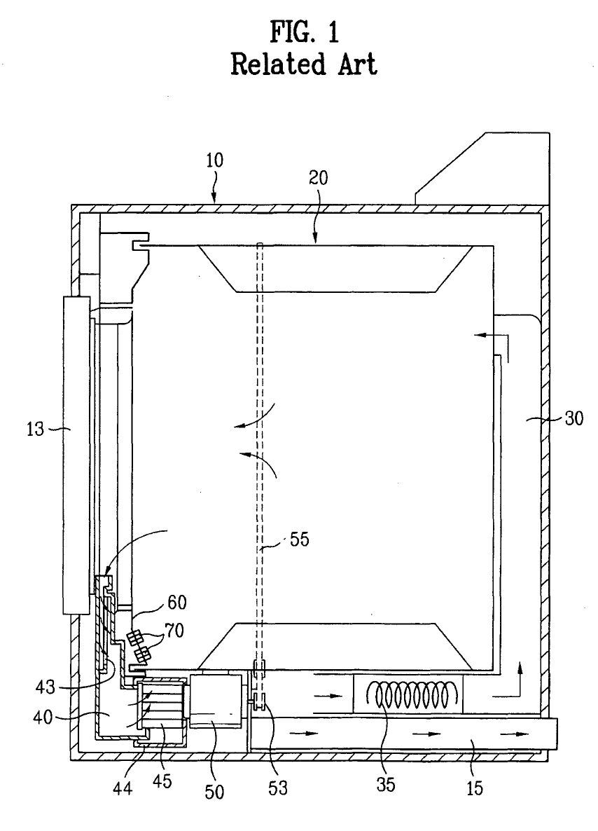

For the sake of easy understanding, the following description is on the basis of an exhaust-type drying apparatus. Accordingly, the same parts as those of the previously described conventional exhaust-type drying apparatus will be designated by the same reference numbers as those of FIG. 1.

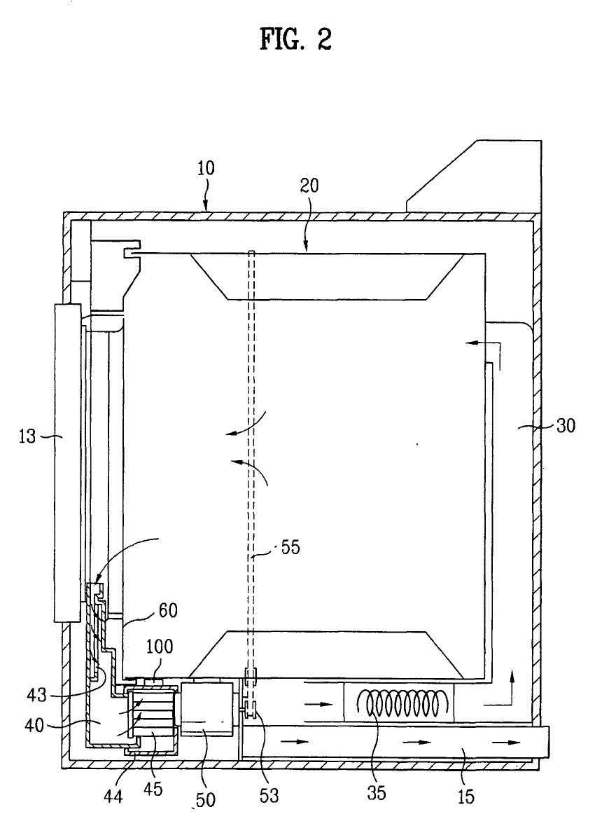

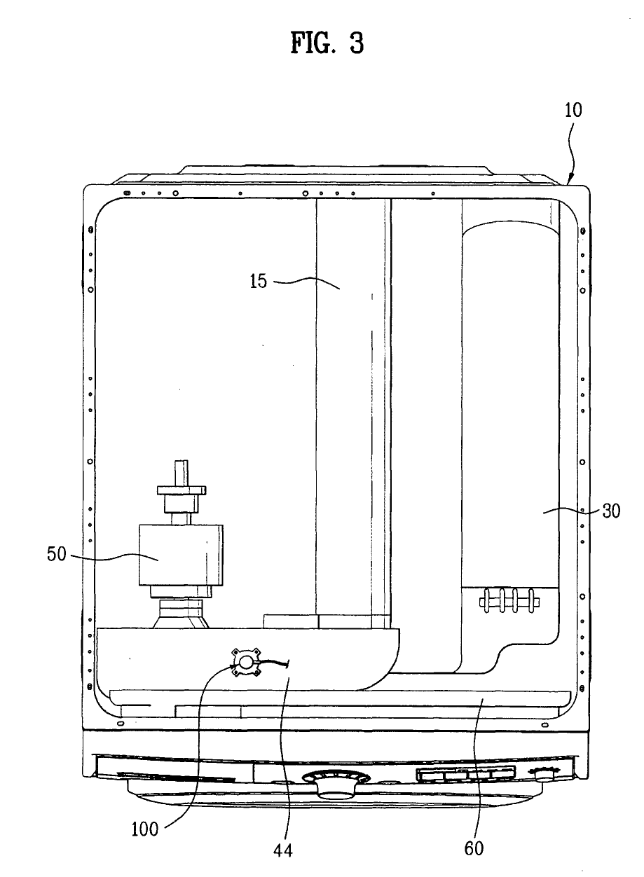

As shown in FIGS. 2 and 3, the conventional exhaust drying apparatus of the present invention comprises a body 10, a drying drum 20 rotatably disposed in the body 10 and adapted to dry a wet object put in the drying drum 20, a drum supporter 60 mounted at a front end of the drying drum 20 and adapted to rotatably support the drying drum 20, and a drive motor 50 connected to the drying drum 20 by use of a power transmission belt 55 and adapted to provide the drying drum 20 with rotating power.

A suction duct 30 is arranged behind the drying drum 20 to suction outside air into the drying drum 20, and a heater 35 is mounted in an entrance of the suction duct 30 to heat the suctioned air.

Here, the suction duct 30 is one of air passages used for suctioning outside air into the drying drum 20 and discharging the air to the outside of the drying apparatus. The air passages also include an exhaust duct 15 that will be explained hereinafter.

A lint duct 40 is mounted in a front lower region of the drying drum 20. The lint duct 40 contains a filter 43 for filtering impurities such as lint contained in the inside air of the drying drum 20, so as to discharge the filtered air from the drying drum 20.

A blowing unit is mounted at an end of the lint duct 40 and adapted to forcibly blow the air, having been suctioned through the lint duct 40, into the exhaust duct 15.

Here, the blowing unit includes a fan housing 44 communicating with the drying drum 20 and the associated air passages, and a blowing fan 45 mounted in the fan housing 44.

Preferably, the fan housing 44 is located in one of the air passages, more particularly, an exhaust passage discharging the inside air of the drying drum 20 to the outside. More preferably, the fan housing 44 is located between the lint duct 40 and the exhaust duct 15.

With this arrangement, the air filtered via the lint duct 40, namely, the pure air having no impurities, is blown by the blowing fan 45. This has the effect of preventing damage to the blowing fan 45 due to impurities discharged from the object 20 being dried in the drying drum 20.

The blowing fan 45 is coupled to a drive shaft (not shown) extending in a direction opposite to a pulley of the drive motor 50. Thereby, the blowing fan 45 is operated simultaneously with the operation of the drive motor 50.

The exhaust duct 15 is mounted such that one end thereof communicates with the outside of the body 10. Thereby, if the air is forcibly blown from the lint duct 40 into the exhaust duct 15 in accordance with the operation of the blowing fan 45, the exhaust duct 15 serves to guide the air to the outside of the drying apparatus.

In the present invention, a humidity sensor 100 is mounted at a side of the fan housing 44. The humidity sensor 100 serves to measure the humidity of the air blown from the lint duct 40.

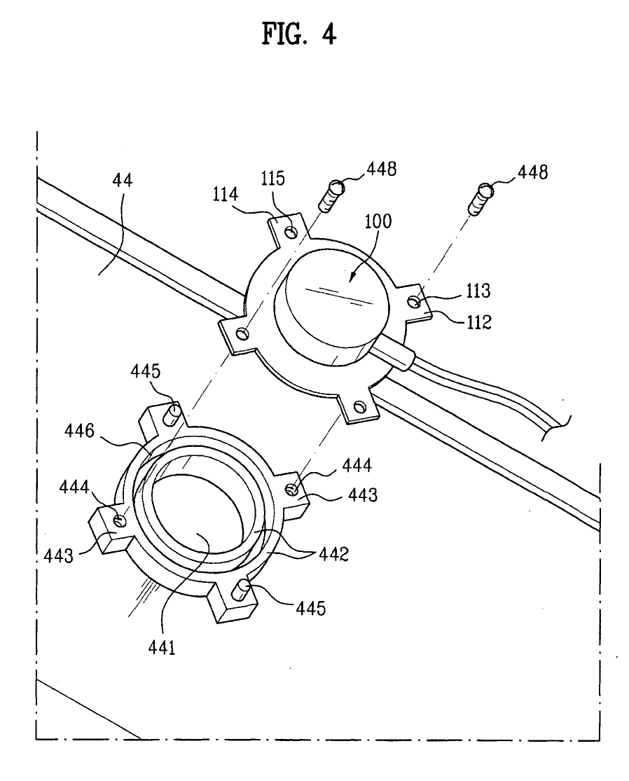

For the installation of the humidity sensor 100, preferably, the fan housing 44 has a through-hole 441 (See. FIG. 4) such that the humidity sensor 100 is mounted at an outer surface of the fan housing 44 around the through-hole 441.

This installation arrangement is efficient to allow the humidity sensor 100 to accurately measure the humidity of the inside air of the drying drum 20.

Prior to being discharged to the outside through the exhaust duct 15, the air discharged from the drying drum 20 has an irregular flow rate at different sections of air passages. This is because impurities generated from the object being dried in the drying drum 20 or the filter 43 of the lint duct 40 may provide the air with resistance.

For this reason, it can be understood that an optimum location where the air can uniformly flow without resistance is the interior of the fan housing 44 because the air, filtered via the lint duct 40, is suctioned into the fan housing 44 and the flow rate of the inside air of the fan housing 44 is uniform by virtue of uniform rotation of the blowing fan 45.

Meanwhile, the humidity sensor 100 is electrically connected to a microcomputer (not shown) that serves as a controller of the drying apparatus.

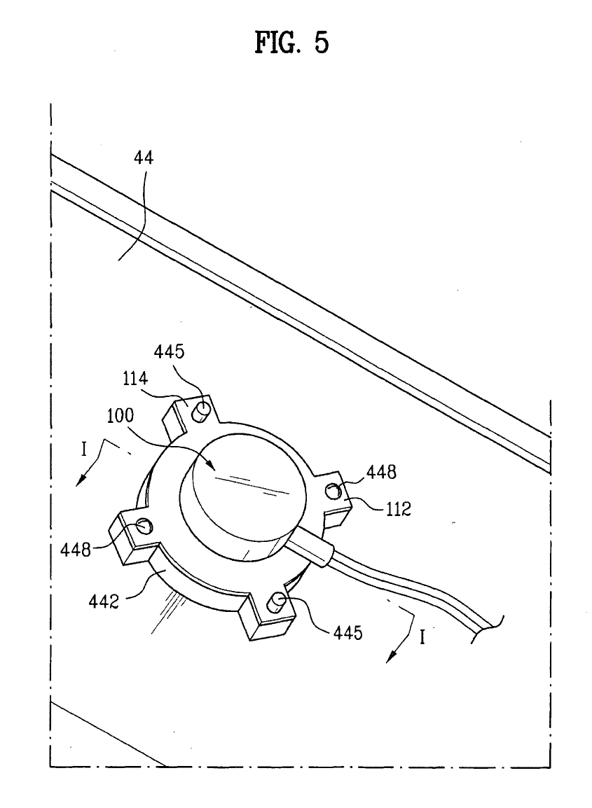

FIGS. 4 and 5 illustrate a structure for mounting the humidity sensor 100 to the fan housing 44 in detail.

As can be seen from FIGS. 4 and 5, a ring-shaped sensor seating rib 442 is formed at the outer surface of the fan housing 44 along an outer periphery of the through-hole 441.

The sensor seating rib 442 is formed along an outer periphery thereof with a plurality of fastening portions 443 for allowing the humidity sensor 100 to be fastened to the sensor seating rib 442.

The sensor seating rib 442 is preferably provided with four fastening portions 443, but is not limited thereto.

In the present embodiment, of the four fastening portions 443, two fastening portions 443 are perforated with screw fastening holes 444, respectively, and the remaining two fastening portions 443 are provided with upwardly extending guide protrusions 445. The fastening portions 443 having the screw fastening holes 444 are alternately arranged with the fastening portions 443 having the guide protrusions 445.

Here, the guide protrusions 445 serve to allow the humidity sensor 100 to be temporarily assembled to the sensor seating ribs 442.

The humidity sensor 100 is integrally formed, along an outer periphery thereof, with fastening pieces 112 for the fastening of screws and guide pieces 114. The fastening pieces 112 and guide pieces 114 are formed at positions corresponding to the fastening portions 443.

The fastening pieces 112 are perforated with screw fastening holes 113 corresponding to the screw fastening holes 444 of the sensor seating rib 442, and the guide pieces 114 are perforated with guide holes 115 for the insertion of the guide protrusions 445.

To couple the humidity sensor 100 around the through-hole 441 of the fan housing 44, first, the guide holes 115 of the guide pieces 114 are inserted to the guide protrusions 445 of the sensor seating rib 442, and then, screws are fastened through the screw fastening holes 113 of the fastening pieces 112 and the screw fastening holes 444 of the fastening portions 443.

In this case, it is desirable that distal ends of the completely fastened screws do not protrude into the fan housing 44.

Once the humidity sensor 100 is coupled around the through-hole 441 of the fan housing 44 as stated above, an outer peripheral surface of a lower portion of the humidity sensor 100 comes into contact with an inner peripheral surface of the sensor seating rib 442, to achieve air tightness therebetween.

The fan housing 44 is thicker at the sensor seating rib 442 than the remaining portion thereof. Accordingly, during the injection molding of the fan housing 44, the fan housing 44 may suffer from shrinkage at the sensor seating rib 442, and thus, have the risk of deformation of the sensor seating rib 442.

Deformation of the sensor seating rib 442, consequently, makes it difficult to maintain air tightness between the humidity sensor 100 and the sensor seating rib 442.

Accordingly, to prevent the deformation of the sensor seating rib 442, it is desirable that a shrinkage proof groove 446 be formed at an upper surface of the sensor seating rib 442 along a circumferential direction of the sensor seating rib 442.

Of course, it is possible that a sealing member such as rubber packing be interposed between the sensor seating rib 442 and the humidity sensor 100, to achieve the desired air tightness therebetween.

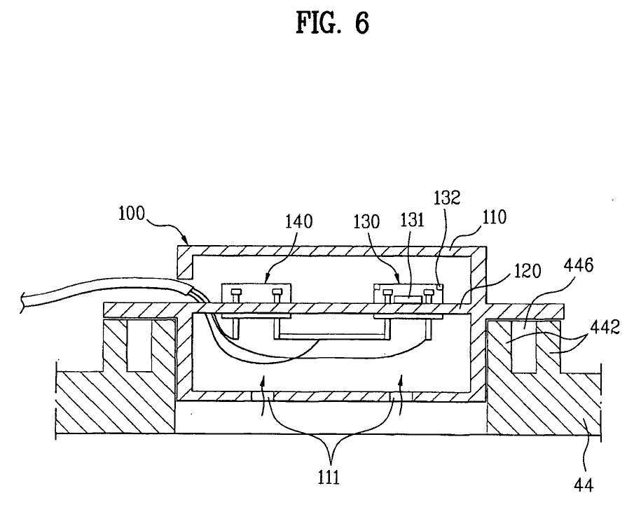

FIG. 6 is a sectional view illustrating the humidity sensor 100 mounted on the sensor seating rib 442.

The humidity sensor 100 includes a case 110 having a plurality of vent holes 111 perforated through the bottom thereof facing the interior of the fan housing 44, and a humidity sensing unit disposed in the case 110.

The humidity sensing unit includes a heat-conductive temperature-compensation plate 120, a humidity sensing element 130, and a compensation element 140.

The humidity sensing element 130 is mounted on the temperature compensation plate 120 at one side location of the plate 120 and adapted to measure a resistance value that is variable in accordance with the humidity of the air introduced into the case 110.

The compensation element 140 is mounted on the temperature compensation plate 120 at the other side location of the plate 120 and adapted to compensate for a resistance value depending on the surrounding temperature.

Although not shown in the drawing, each of the humidity sensing element 130 and compensation element 140 is internally provided with a micro-heater.

If a voltage of approximately 5 to 10V is applied to both ends of the micro-heater, a surface temperature of the micro-heater is changed, causing a variation in the resistance value.

The humidity sensor 100 is operable on the basis of a property in that a voltage value is variable in accordance with the variation of the resistance value.

The humidity sensing element 130 is formed at opposite side locations thereof with a pair of air inlets 131, to allow the air to be introduced thereinto.

Accordingly, the humidity sensing element 130 is affected by the humidity of the air introduced through the air inlets 131.

On the other hand, the compensation element 140 may have no air inlet, differently from the humidity sensing element 130.

Accordingly, the compensation element 140 is affected by the temperature of the surrounding air.

In this configuration, since the temperature of the humid air introduced into the humidity sensing element 130 is lower than that of the surrounding air, the resistance value of the humidity sensing element 130 is smaller than that of the compensation element 140.

Thereby, the microcomputer is able to detect the humidity of the air by measuring a difference in voltage values from a difference between the resistance values of the humidity sensing element 130 and compensation element 140.

Meanwhile, the temperature compensation plate 120 serves to compensate for a temperature difference between the humidity sensing element 130 and compensation element 140.

Now, the operation of the exhaust-type drying apparatus according to the preferred embodiment of the present invention will be explained.

If a wet object to be dried, for example, clothes, is put in the drying drum 20, a drying cycle of the drying apparatus begins.

For this, first, the drive motor 50 is operated to rotate the drying drum 20 and blowing fan 45 simultaneously, and also, the heater 35 begins to operate.

As the blowing fan 45 is operated by the drive motor 50, the outside air is introduced into the suction duct 30, to thereby be heated by the heater 35.

Then, the heated air is introduced into the drying drum 20 being rotated, so as to be used to dry the wet object.

After being used to evaporate the moisture of the object being dried and to dry the object, the resulting low-temperature and high-humidity air inside the drying drum 20 is moved into the lint duct 40.

Thereafter, the air, introduced into the lint duct 40, is filtered while passing through the filter 43, and then, is discharged to the outside by way of the exhaust duct 15 in accordance with the operation of the blowing fan 45.

In the above described drying cycle, the air, discharged from the drying drum 20, is guided to pass through the fan housing 44.

While passing through the fan housing 44, a part of the air is moved to the through-hole 441, to thereby be introduced into the vent holes 111 of the humidity sensor 100 facing the through-hole 441.

Thereby, the humidity of the air introduced into the case 110 can be measured by the humidity sensing unit. Finally, on the basis of the measured result, the microcomputer detects the dryness of the object being dried, and controls the drying cycle of the drying apparatus.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A drying apparatus comprising:
a drum receiving an object to be dried;
an air passage communicating with the interior of the drum;
a blowing unit mounted in the air passage for forcibly blowing the inside air of the drum; and
a humidity sensor mounted in the blowing unit for measuring the humidity of the air blown from the drum.

2. The drying apparatus as set forth in claim 1,
wherein the blowing unit includes:
a fan housing communicating with both the drum and air passage; and
a blowing fan mounted in the fan housing, and
wherein the humidity sensor is mounted to the fan housing.

3. The drying apparatus as set forth in claim 2, wherein the fan housing has a through-hole, and the humidity sensor is mounted on the fan housing around the through-hole.

4. The drying apparatus as set forth in claim 3, wherein the humidity sensor is mounted to cover the through-hole at the outside of the fan housing.

5. The drying apparatus as set forth in claim 1, wherein the humidity sensor includes:
a case having a vent hole perforated through a side thereof facing the interior of the fan housing; and
a humidity sensing unit mounted in the case for measuring a humidity value of air introduced through the vent hole.

6. The drying apparatus as set forth in claim 5, wherein at least one vent hole is provided.

7. The drying apparatus as set forth in claim 5, wherein the humidity sensing unit includes:
a humidity sensing element having a variable resistance value depending on the humidity of air introduced through the vent hole; and
a compensation element for compensating for a resistance value depending on the temperature of surrounding air.

8. The drying apparatus as set forth in claim 7, wherein the humidity sensing unit further includes a temperature compensation plate connected to both the humidity sensing element and compensation element for compensating for a temperature difference between the humidity sensing element and compensation element.

9. The drying apparatus as set forth in claim 4,
wherein the fan housing has a sensor seating rib formed at an outer surface thereof for allowing the humidity sensor to be seated thereon, and
wherein a fixture is provided for fixedly coupling the humidity sensor to the sensor seating rib.

10. The drying apparatus as set forth in claim 9, wherein the sensor seating rib takes the form of a ring protruding from the outer surface of the fan housing along an outer periphery of the through-hole.

11. The drying apparatus as set forth in claim 9, wherein the fixture includes:
a plurality of fastening portions extending radially from an outer periphery of the sensor seating rib;
a plurality of fastening pieces formed at the humidity sensor to correspond to the fastening portions, respectively; and
a plurality of screws penetrating through the fastening portions and fastening pieces, to fixedly couple the humidity sensor to the sensor seating rib.

12. The drying apparatus as set forth in claim 11, wherein at least one of the fastening portions of the sensor seating rib is formed with an upwardly-extending guide protrusion, and at least one of the fastening pieces of the humidity sensor is formed with a guide hole for the insertion of the guide protrusion.

13. The drying apparatus as set forth in claim 12, wherein at least one guide protrusion and at least one guide hole are provided.

14. The drying apparatus as set forth in claim 10, wherein a shrinkage proof groove is formed at an upper surface of the sensor seating rib in a circumferential direction.

15. The drying apparatus as set forth in claim 9, further comprising:
a sealing member interposed between the sensor seating rib and the humidity sensor for achieving air tightness therebetween.
